(19) United States
(12) Patent Application Publication
(10) Pub. No.: US 2017/0276545 A1
(43) Pub. Date: Sep. 28, 2017

(54) AN IMAGING SYSTEM PARALLELIZING COMPRESSIVE SENSING IMAGING

(71) Applicant: TOTALFOERSVARETS FORSKNINGSINSTITUT, Stockholm (SE)

(72) Inventor: Markus HENRIKSSON, Brokind (SE)

(73) Assignee: TOTALFOERSVARETS FORSKNINGSINSTITUT, Stockholm (SE)

(21) Appl. No.: 15/504,939

(22) PCT Filed: Jul. 24, 2015
(86) PCT No.: PCT/SE2015/000048

§ 371 Date: Feb. 17, 2017

(30) Foreign Application Priority Data
Aug. 21, 2014 (SE) 1400400-6

(51) Int. Cl. G01J 3/28; H04N 13/02; H04N 5/33; G01J 3/02

(52) U.S. Cl. CPC G01J 3/2823; G01J 3/0229; H04N 13/0203; H04N 5/332; G01J 2003/2826

(57) ABSTRACT

The invention relates to an imaging system parallelizing compressive sensing (CS). The system comprises a linear detector array (109,211) resolving image information along its extent with the help of focusing the incoming radiation on the detector pixels using astigmatic optics (108,212) and in that the image direction perpendicular to the extent of the detector array is resolved by the use of a number of spatial patterns on the spatial light modulator together with compressive sensing processing.

This invention relates to an imaging system parallelizing compressive sensing (CS). The system is using a linear detector array and astigmatic optics.

It is a common task to measure photons arriving from a scene on a two-dimensional (2D) domain. This is performed in every camera. For some applications it is not sufficient to measure the amount of light arriving during a certain time period as is done in normal CCD and CMOS sensors, but some type of measurement that is difficult to perform in a 2D array detector is needed. This may be a problem of manufacturing, e.g. because the measurement is to be performed at a wavelength where current semiconductor technology does not produce good quality 2D array detectors of sufficient size at a reasonable price. It may also be because a more difficult measurement is to be performed. This measurement may be sampling of a reflected laser pulse with high temporal resolution to provide three-dimensional (3D) information about the target. It may also be a spectrally resolved measurement where every pixel needs to perform a number of measurements at different wave-lengths.

Traditionally this problem has been solved by scanning optics so that every pixel, or every row of pixels, has been measured sequentially. Early infrared (IR) cameras used this technology. Further, scanning laser radar for 3D measurements is a well-known and often used technology. Hyper-spectral imaging is often performed with push broom technology where the movement of the sensor provides the resolution in one direction, while the 2D array detector provides spatial information in the other direction and, with the help of a dispersive element, spectral information.

A method developed in recent years using a single detector to provide 2D information faster than traditional scanning is single pixel imaging using compressive sensing, also known as compressed sensing, compressive sampling (CS) or compressive imaging; please cf. Baraniuk, R. G., Baron, D. Z., Duarte, M. F., Kelly, K. F., Lane, C. C., Laska, J. N., . . . Wakin, M. B. (2012): Method and apparatus for compressive imaging device, herby incorporated by reference. This technology has been suggested for 3D-imaging; please cf. Baraniuk, R. G., Kelly, K. F., & Woods, G. L. (2011): Temporally and spatially resolved single photon counting using compressive sensing for debug of integrated circuits, lidar and other applications, herby incorporated by reference. This has also been demonstrated; please cf. Howland, G. A., Dixon, P. B., & Howell, J. C. (2011): Photon-counting compressive sensing laser radar for 3D imaging. Applied optics, 50 (31), 5917-5920, herby incorporated by reference. In this technology the 2D detector array in a traditional camera architecture is replaced by a spatial light modulator (SLM), which can e.g. be a digital micro-mirror device (DMD). A pattern applied to the DMD will reflect the light incident on certain pixels towards a lens collecting all the light onto a single detector. Light incident towards other pixels on the DMD will be directed away from this lens. In this way a measurement by a single detector will sample a linear combination of pixels in the image. A new measurement using a different pattern on the DMD will sample a different linear combination of pixels. If a number of measurements equal to the number of pixels in the array are performed using patterns that are basis vectors of the space spanned by the array this will produce a linear equation system that can be solved using traditional minimization of the squared error or L2-norm.

The purpose of CS is to reduce the number of measurements that needs to be performed compared to a scanned system. This will produce an underdetermined linear equation system, which has infinitely many solutions. In CS the fact that most data can be described sparsely in some base is used. A reconstruction base is selected, and the most sparse description, that is the one that could produce the measurement results using the least number of non-zero basis coefficients, is assumed to be correct. The reconstruction basis can be the normal pixel basis or any basis that is suitable for describing the scene in a sparse way, for example different wavelet bases are often suitable for natural scenes in analogy with the jpeg 2000 compression. Different bases should be chosen depending on the type of scene that is imaged. A scene consisting of a few bright points in a dark background, as could happen in thermal imaging, should be described by the pixel basis. A scene consisting of several surfaces with different characteristics should instead be described by a wavelet basis.

Mathematically the process can be described as follows for 2D-imaging. Let f be the scene as it would be seen by a normal camera in the position of the DMD. Let the DMD and the imaginary camera have N² pixels. The DMD could also be rectangular, but a quadratic array is assumed here for illustrational purposes. Randomly selected patterns for the mirrors can be written as N² long vectors of zeroes and ones, placed as rows of the matrix Φ. Conducting M measurements with different patterns for the DMD can then be written as

b=Φf,

where b is an M-long column vector containing the measurement results. The scene can also be described as

f=Ψx,

where Ψ is a basis matrix containing all basis vectors for the reconstruction basis. If the pixel basis is used for reconstruction Ψ is the identity matrix. It is important that Φ and Ψ are uncorrelated to each other. This is valid for all reconstruction bases when using randomly generated patterns for the DMD. The N²-element vector x is the description of the scene in the reconstruction basis. For CS to be of use x should be a sparse vector with only a small number of non-zero values.

The problem to solve can then be written as

b=ΦΨx=Ax,

where A is an M×N² matrix with M<<N². The correct solution to this underdetermined linear equation system can according to the theory of CS be found by minimization of the L₁-norm, which is the sum of the absolute values of all coefficients in x, while keeping the equality. Methods for this and extensions to handle noise in measurements include basis pursuit and other similar methods. Functions to perform this minimization are available e.g. in the SPGL1-(Spectral Projected Gradient for L1 minimization) package at http://www.cs.ubc.ca/labs/sci/spgl1/2.

One problem of CS is that for high definition imaging the number of measurements needed are not small, thus the sequential measurements using different patterns on the DMD take time. In addition the reconstruction also becomes very computationally demanding when the equation system becomes large. Kelly et al. have suggested reducing this problem by directing sub-images to different discrete detectors; please cf. Kelly, K. F., Baraniuk, R. G., Mcmackin, L., Bridge, R. F., Chatterjee, S., & Weston, T. H. (2012): Decreasing image acquisition time for compressive imaging devices, hereby incorporated by reference. Baraniuk et al. have further discussed the use of re-imaging optics between the DMD and a smaller detector array to multiply the resolution of the detector; please cf. Baraniuk, R. G., Kelly, K. F., & Woods, G. (2013): Number of pixels in detector arrays using compressive sensing, hereby incorporated by reference.

The present invention solves the problem of long measurement times in compressed sensing by parallelizing the measurement using astigmatic optics and a linear detector array in the way that is evident from the following independent claim. The remaining claims concern advantageous embodiments of the invention.

The invention will in the following be described with reference to the accompanying drawings, in which:

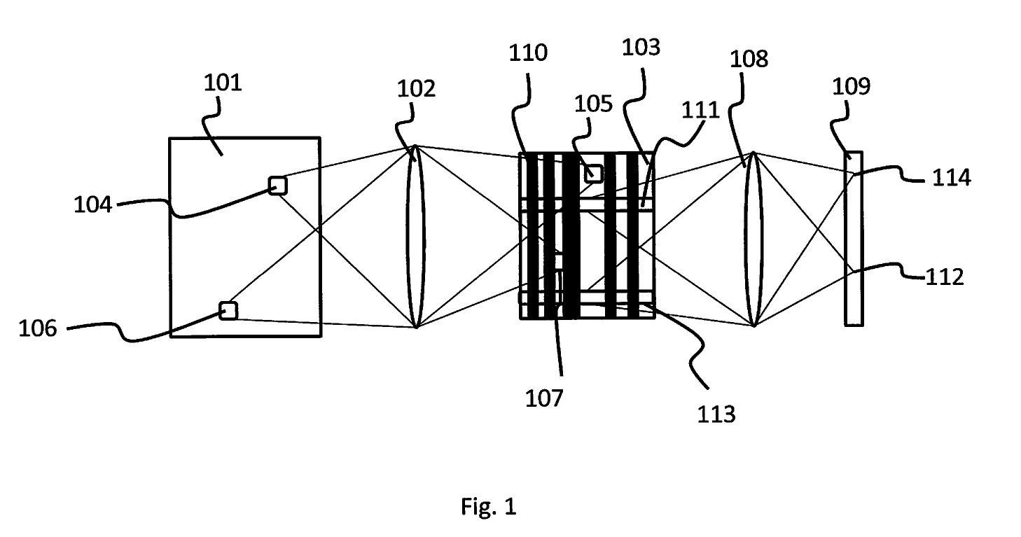

FIG. 1 is an illustration of an embodiment of the invention where the scene is imaged onto a spatial light modulator (SLM) using standard imaging optics. The SLM imposes a line pattern mask onto the image. Each row of SLM pixels is then re-imaged onto one pixel of a linear detector array using astigmatic optics and

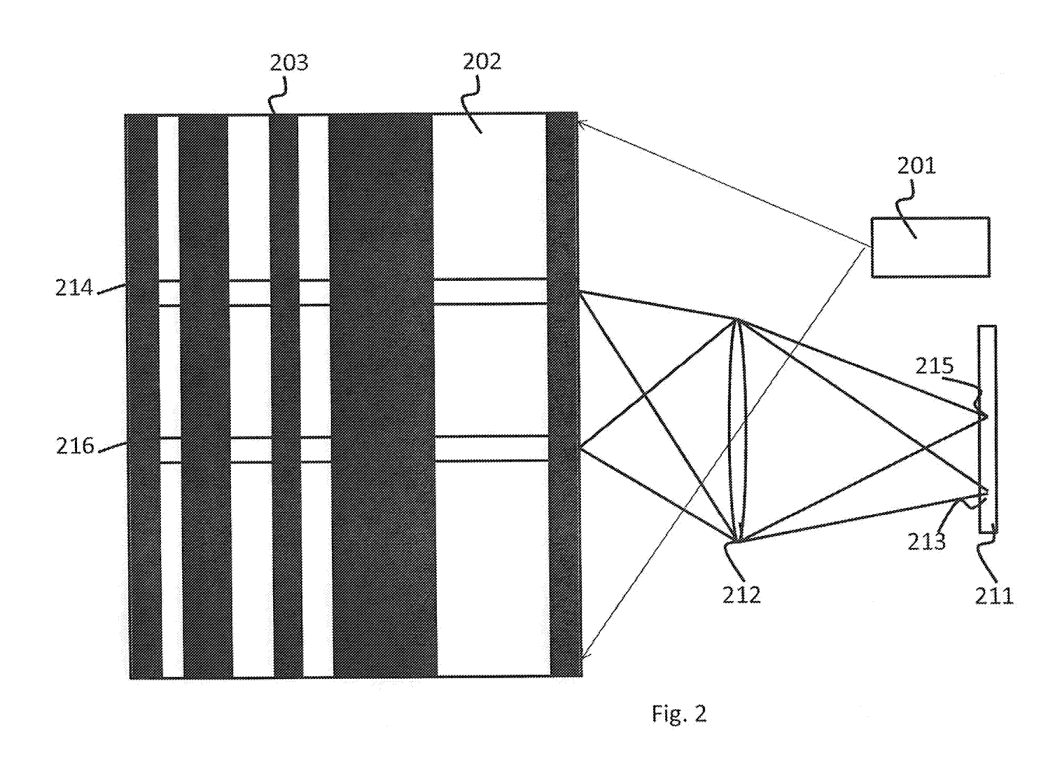

FIG. 2 is an illustration of an embodiment of the invention where the pattern is created by the illumination source and an astigmatic camera lens images the scene onto a linear array detector.

In many more complex imaging systems fabrication of large array detectors is a problem. It may be simply a problem of manufacturing technology where large detectors would have low yield and very high cost, as for e.g. infrared imaging. It may also be a problem of complex electronics necessary for every pixel, as in 3D laser radar detectors. In a linear detector array the electronics can expand to the sides without increasing the pixel pitch along the array dimension. This is of course not possible in a 2D detector. Another situation where 2D detector arrays are difficult is hyper-spectral imaging where the spectrum needs to be resolved in addition to the two spatial dimensions. Here it is common to use a 2D detector for the spectral and one spatial dimension and scan the second spatial dimension. CS using astigmatic optics could improve the efficiency of this setup, by removing the need to scan the slit-shaped field of view.

Current DMD technology allows 1920×1080 pixels with 23148 Hz frame rate and 10.8 μm pixel pitch (Texas Instruments chipset 0.95 1080p). The size of DMD arrays is expected to continue to increase. If the full DMD is used for a single CS measurement the number of dimensions will be very high (2073600), causing the need for many measurements and hence slow frame rates. By using a linear detector array with 1×1080 pixels and astigmatic optics this is reduced to 1080 CS measurements, each with 1920 dimensions. This is a very reasonable problem size where each reconstructed frame can be collected with fifty to a few hundred DMD patterns, using integration times of 10-200 μs for each mirror pattern, and hence a frame rate of around 100 Hz can be achieved for low information content scenes and good illumination conditions. For lower illumination levels longer integration times for each mirror pattern can be used to acquire the signal at the cost of lower frame rates. There is basically no limit to what integration times can be used, it only depends on the dynamic range of the detector and the light conditions. For an active illumination system multiple laser pulses can be used for the same mirror pattern and the signals added to improve the signal to noise ratio. For moderately complex scenes the compressed sensing algorithm will need a larger number of mirror patterns, but the method may be of advantage compared to classical scanning up to over 50% of the number of dimensions.

The smaller pixel pitch of the DMD makes long focal length imaging lenses unnecessary, potentially reducing the overall size of the imaging system even with the increased complexity of the CS setup compared to a normal camera.

In a preferred embodiment, illustrated in FIG. 1, suitable for passive imaging, e.g. infrared imaging, but also for active 3D imaging with pulsed laser illumination, the invention is an imaging detector where the varying pattern used for the compressed sensing (CS) processing is applied in the detection system. The imaging system consists of a lens system imaging the scene onto a spatial light modulator (SLM) comprising N×P pixels. Different patterns are applied to the SLM where the pixels direct the radiation into a further re-imaging system or block the radiation depending on the pixel values in the pattern applied to the SLM. In a preferred embodiment all P rows would use the same patterns, but different patterns for different rows are also possible. The re-imaging system comprises astigmatic optical elements so that the radiation from each row of N pixels of the SLM is collected onto different pixels in a P pixel linear detector array. In this way P simultaneous measurements are performed for each pattern on the SLM and M patterns will produce data to solve P different underdetermined linear equation systems with a M×N matrix describing each equation system.

In one preferred embodiment the SLM is a digital micro-mirror device (DMD). Other possibilities for the SLM include pixelated liquid crystal cells.

The illustration in FIG. 1 shows an imaging system that studies a field of view 101. The scene inside the field of view could be illuminated by a light source included in the system, be illuminated by ambient light from e.g. the sun, or the thermal radiation from the objects in the scene can be used as light source. If a dedicated light source is included this could be e.g. a pulsed laser for 3D-imaging or a super-continuum laser for hyper-spectral imaging. This scene is imaged by optics 102 onto an SLM 103. The optics 102 could be a standard camera lens or a telescope suitable for the wavelength of interest. The optics images a small area 104 onto one position 105 on the SLM and other areas 106 onto other positions of the SLM 107, just like regions of the scene are imaged onto pixels of a CCD detector in a standard camera. A second astigmatic optical system 108 images the radiation reflected from or transmitted by the SLM 103 onto a linear detector array 109. The SLM is used to create patterns of vertical lines 110 on the SLM 103 where all or none of the radiation is directed towards the linear detector array 109 based on if that line on the SLM is assigned 1 or 0 in the pattern mask. The astigmatic optical system 108 images slit like regions, e.g. 111 and 113 of the SLM, that are crossing the stripe pattern 110, onto different pixels, 112 and 114 respectively, on the linear detector array 109. Different patterns 110 are used sequentially with one detector reading taken for each pattern to produce a dataset than can be used in compressed sensing reconstruction of the scene. The data from each pixel in the linear detector array produces the image of one line in the scene and these linear images are then stacked together to form a 2D image.

In one embodiment the astigmatic part of the re-imaging system consists of one or more cylinder lenses. In another embodiment the re-imaging system consists solely of mirrors, where a cylindrical or toroidal mirror provides the astigmatism. In one preferred embodiment for 3D imaging applications an off axis cylindrical mirror is used as the astigmatic re-imaging optics in such a way as to keep the time delay between SLM and detector equal for all pixels on the SLM.

In one preferred embodiment the scene is illuminated by a pulsed laser and each pixel in the linear detector array comprises a temporally resolved detector circuit to provide 3D information about the scene through the time-of-flight laser radar principle. In one embodiment this temporally resolved detector circuit is a photodiode and a sampling circuit comprising a number of memory registers to provide a dense temporal sampling of the received radiation intensity. The linear architecture of the detector array allows dense packing of the detectors along the line at the same time as there is ample space for electronics for the sampling. In another embodiment the detector array consists of a row of single photon avalanche diode (SPAD) detectors, each with separate electronics for collecting histograms of photon arrival times. This detector system comprises a time-correlated single-photon counting (TCSPC) laser radar system. The linear detector array for a TCSPC-system may also consist of other photon counting detectors, e.g. superconducting nanowire single photon detectors. In one embodiment the linear detector is the slit of a streak camera, allowing very high temporal resolution.

The TCSPC-system may also be used for fluorescence lifetime imaging (FLIM) in an embodiment very similar to the one described for 3D-measurement, but with the time delay caused by molecular excitation and fluorescence.

In one preferred embodiment the astigmatic re-imaging system also includes a dispersive element to re-image the N×P pixels of the SLM onto a Q×P pixel detector array, where each row of N pixels is redirected onto one row of Q pixels so that one wavelength component arrives at each of the Q pixels to produce a hyper-spectral imaging system. Every column of the Q×P pixel array is then a sensor of the type described in the monochromatic implementations of this invention. The hyper-spectral sensor can be implemented either by placing the dispersive element in front of the focus of the astigmatic re-imaging system, or in the focus with a second re-imaging system directing the light to the detector array. In one embodiment the dispersive element is a prism. In another embodiment the dispersive element is a grating.

A simpler multispectral embodiment uses one or more chromatic beam splitters to direct the light to two or more discrete linear detector arrays.

In one embodiment the two mirror positions of the DMD reflect radiation into two different but identical astigmatic optical system and linear detector array systems, that by subtraction of the measurement data produce a random sampling matrix (Φ) consisting of values −1 and 1 instead of 0 and 1. This is used to improve numerical stability in the reconstruction process and hence reduce the number of measurements necessary, following the results of Sale et al.; please cf. Sale, D., Rozell, C. J., Romberg, J. K., & Lanterman, A. D. (2012): Compressive ladar in realistic environments. In 2012 IEEE Statistical Signal Processing Workshop (pp. 720-723), hereby incorporated by reference.

In one preferred embodiment illustrated in FIG. 2 the patterns for compressed sensing processing are applied in the illumination source. A spatial light modulator projects a pattern of illuminated lines on the scene. A detector system comprising an astigmatic imaging system and a linear detector array is used so that the field of view of each detector is a stripe perpendicular to the illuminated lines on the target. In one embodiment the illumination source is a pulsed laser to provide 3D information about the scene.

The illustration in FIG. 2 shows an imaging system where the light source 201 illuminates the whole field of view 202 in a pattern of vertical stripes 203. The light source includes a spatial light modulator to produce a changing set of vertical stripes. The spatial light modulator may be a DMD, and the full light source may be a standard computer projector. Light sources based on pulsed lasers, but otherwise similar to a projector, are suitable for longer ranges and 3D-imaging. The receiver subsystem consists of a linear detector array 211 and an astigmatic optical system 212. In the simplest implementation the astigmatic optical system is a cylindrical lens. More complex systems consisting of multiple lens elements or cylindrical or toroidal mirrors to improve the light collection capacity of the detector subsystem are possible. A single pixel 213 of the linear detector array will have a horizontal slit like field of view 214 crossing the stripes produced by the light source. A different pixel 215 will have a similar field of view 216 at a different vertical position in the total field of view 202. By performing a number of measurements with different patterns of vertical light stripes each detector element in the linear detector array will produce a set of collected data, which together with applied patterns of light stripes can be used to reconstruct the scene inside the horizontal slit seen by that detector element using compressive sensing reconstruction where the solution to a underdetermined linear equation system that maximizes the spasity of the scene is found. By adding these slit like scenes as lines in an image a two-dimensional image can be built.

A number of other concrete embodiments of the invention are possible and obvious within the inventive concept to the skilled man implementing the invention.

1. An imaging device comprising a detector array (109,211) and a spatial light modulator (103), said imaging system resolving a two-dimensional area (101,202) using compressive sensing, characterised in that the detector is a linear detector array resolving image information along its extent with the help of focusing the incoming radiation on the detector pixels using astigmatic optics (108,212) and in that the image information perpendicular to the extent of the detector array is resolved by the use of a number of spatial patterns on the spatial light modulator together with compressive sensing processing, thereby producing a number of compressive sensing reconstruction problems equal to the number of pixels in the linear detector array, each with a mathematical dimension equal to the number of elements in the spatial light modulator patterns perpendicular to the extent of the detector array.

2. An imaging system according to claim 1, characterised in that said spatial light modulator (103) creates a strip pattern (110,203) parallel to the direction of the linear detector array (109,211).

3. An imaging system according to claim 1, characterised in that a system (201) illuminating the scene to be imaged includes the spatial light modulator.

4. An imaging system according to claim 1, characterised in that it comprises standard imaging optics that produces an image of the scene (101) to be imaged on the spatial light modulator (103), and that light transmitted or reflected by the spatial light modulator is re-imaged onto the linear detector (109) array by the astigmatic optics (108).

5. An imaging system according to claim 4, characterised in that the spatial light modulator (103) is a digital micro-mirror device and the imaging system comprises two sets of a linear detector array (109) and its astigmatic re-imaging optics (108), that light reflected in two directions from the digital micro-mirror device is collected by the respective linear detector arrays, and that the two detector readings from the detector arrays are subtracted one from the other to increase numerical stability.

6. An imaging system according to claim 1, characterised in that the linear detector array (109,211) consists of hyper-spectral detectors implemented as a dispersive element and a two-dimensional detector array.

7. An imaging system according to claim 1, characterised in that it comprises a pulsed light source (201) illuminating the scene to be imaged and that the linear detector array (211) consists of temporally resolved detectors to produce a 3D-image of the scene.
